(19) United States
(12) Patent Application Publication
(10) Pub. No.: US 2019/0196474 A1
(43) Pub. Date: Jun. 27, 2019

(54) CONTROL METHOD, CONTROL APPARATUS, CONTROL DEVICE, AND MOVABLE PLATFORM

(71) Applicant: SZ DJI TECHNOLOGY CO., LTD., Shenzhen (CN)

(72) Inventors: Jie QIAN, Shenzhen (CN); Haonan LI, Shenzhen (CN); Cong ZHAO, Shenzhen (CN)

(21) Appl. No.: 16/292,897

(22) Filed: Mar. 5, 2019

Related U.S. Application Data
(63) Continuation of application No. PCT/CN2016/110059, filed on Dec. 15, 2016.

(51) Int. Cl. G05D 1/00; G05D 1/02

(52) U.S. Cl. CPC G05D 1/0094; G05D 1/0246; G05D 1/027

(57) ABSTRACT

A control method includes determining a movement direction of a movable platform, and controlling, according to the movement direction of the movable platform, an orientation of the movable platform to cause a detection device carried by the movable platform to approximately align with the movement direction.

### CROSS-REFERENCE TO RELATED APPLICATION

This application is a continuation application of International Application No. PCT/CN2016/110059, filed on Dec. 15, 2016, the entire contents of which are incorporated herein by reference.

### TECHNICAL FIELD

The present disclosure relates to the control field and, more particularly, to a control method, a control apparatus, and a control device for a movable platform, and a movable platform.

### BACKGROUND

A movable platform, such as an unmanned aerial vehicle (UAV) or a remotely-controlled photographing car, is provided with one or more detection devices such as a radar, a binocular obstacle avoidance system, and/or an ultrasonic wave system at a nose of the movable platform, for detecting obstacles around the movable platform to avoid a collision between the movable platform and obstacles in the front during a movement of the movable platform.

When a movable platform photographs an object, a controller of the movable platform may control a gimbal to rotate, such that a photographing device can keep track of a target object for photographing or can photograph the target object from different angles. As such, a movement direction of the movable platform may differ from a photographing direction of the photographing device. When the nose of the movable platform points to the target object, a detection direction of the detection device at the nose may be inconsistent with the movement direction of the movable platform. The movable platform may detect obstacles in a direction of the nose, and may not detect obstacles on the left or on the right. When the nose of the movable platform points toward the target object, while the movable platform moves to the left, to the right, or backward, the movable platform may crash into an obstacle on the left, on the right, or behind.

### SUMMARY

In accordance with the disclosure, there is provided a control method. The control method includes determining a movement direction of a movable platform; and controlling, according to the movement direction of the movable platform, an orientation of the movable platform to cause a detection device carried by the movable platform to approximately align with the movement direction.

Also in accordance with the disclosure, there is provided a control device. The control device includes one or more processors and a memory storing instructions. The instructions, when executed by the one or more processors, cause the one or more processors to determine a movement direction of a movable platform; and control, according to the movement direction of the movable platform, an orientation of the movable platform to cause a detection device carried by the movable platform to approximately align with the movement direction.

### BRIEF DESCRIPTION OF THE DRAWINGS

FIG. 1 illustrate a schematic view of an exemplary unmanned aerial vehicle (UAV) and a target object for photographing according to various disclosed embodiments of the present disclosure.

FIG. 2 illustrate a schematic view of another exemplary UAV and a target object for photographing according to various disclosed embodiments of the present disclosure.

FIG. 3 illustrates a flowchart of an exemplary control method according to various disclosed embodiments of the present disclosure.

FIG. 4 illustrates a schematic view of an exemplary XOY plane of a world coordinate system according to various disclosed embodiments of the present disclosure.

FIG. 5 illustrates a schematic view of another exemplary XOY plane of a world coordinate system according to various disclosed embodiments of the present disclosure.

FIG. 6 illustrates a schematic view of adjusting an orientation of an exemplary UAV according to various disclosed embodiments of the present disclosure.

FIG. 7 illustrates another schematic view of adjusting an orientation of an exemplary UAV according to various disclosed embodiments of the present disclosure.

FIG. 8 illustrates a flowchart of another exemplary control method according to various disclosed embodiments of the present disclosure.

FIG. 9 illustrates a schematic view of a movement direction of an exemplary UAV according to various disclosed embodiments of the present disclosure.

FIG. 10 illustrates a flowchart of another exemplary control method according to various disclosed embodiments of the present disclosure.

FIG. 11 illustrates another schematic view of adjusting an orientation of an exemplary UAV according to various disclosed embodiments of the present disclosure.

FIG. 12 illustrates another schematic view of adjusting an orientation of an exemplary UAV according to various disclosed embodiments of the present disclosure.

FIG. 13 illustrates another schematic view of adjusting an orientation of an exemplary UAV according to various disclosed embodiments of the present disclosure.

FIG. 14 illustrates another schematic view of adjusting an orientation of an exemplary UAV according to various disclosed embodiments of the present disclosure.

FIG. 15 illustrates a flowchart of another exemplary control method according to various disclosed embodiments of the present disclosure.

FIG. 16 illustrates a block diagram of an exemplary control device according to various disclosed embodiments of the present disclosure.

FIG. 17 illustrates a block diagram of an exemplary UAV according to various disclosed embodiments of the present disclosure.

FIG. 18 illustrates a block diagram of an exemplary control apparatus according to various disclosed embodiments of the present disclosure.

FIG. 19 illustrates a block diagram of another control apparatus according to various disclosed embodiments of the present disclosure.

Reference numerals used in the drawings include: 1, positive direction of X-axis of gimbal coordinate system; 2, negative direction of X-axis of gimbal coordinate system; 3, positive direction of Y-axis of gimbal coordinate system; 4, negative direction of Y-axis of gimbal coordinate system; 5, positive direction of Z-axis of gimbal coordinate system; 6, negative direction of Z-axis of gimbal coordinate system; 9, first minor arc; 11, propeller; 12, fuselage; 13, detection device; 14, gimbal; 15, photographing device; 16, photographing lens; 17, optical axis direction; 20, target object; 60, unmanned aerial vehicle (UAV); 61, detection direction of detection device; 62, movement direction of UAV; 63, detection device; 64, second minor arc; 65, major arc; 66, photographing direction of photographing device; 67, rotation angle; 68, rotation angle; 160, control device; 161, processor; 162, filter; 163, communication interface; 100, UAV; 21, detection device; 107, motor; 106, propeller; 117, electronic speed regulator; 118, control device; 108, sensing system; 110, communication system; 102, supporting device; 104, photographing device; 112, ground-based station; 114, antenna; 116, electromagnetic wave; 180, control apparatus; 181, determination circuit; 182, control circuit; 183, filter circuit; 184, substitution circuit; and 185, receiving circuit.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Further, in the present disclosure, the disclosed embodiments and the features of the disclosed embodiments may be combined when there are no conflicts.

A movable platform of the present disclosure may include any movable object provided with a detection device for detecting obstacles. The movable platform may include, for example, an unmanned aerial vehicle (UAV), a remote picture-taking vehicle, etc. One or more UAVs are described below as examples of the movable platform for illustrative purposes, and the one or more UAVs in the following descriptions can be replaced with one or move other movable platforms. Movable platforms of the present disclosure are not limited to the UAVs, and other types of movable platforms may be selected by those skilled in the art, all of which are within the scope of the present disclosure.

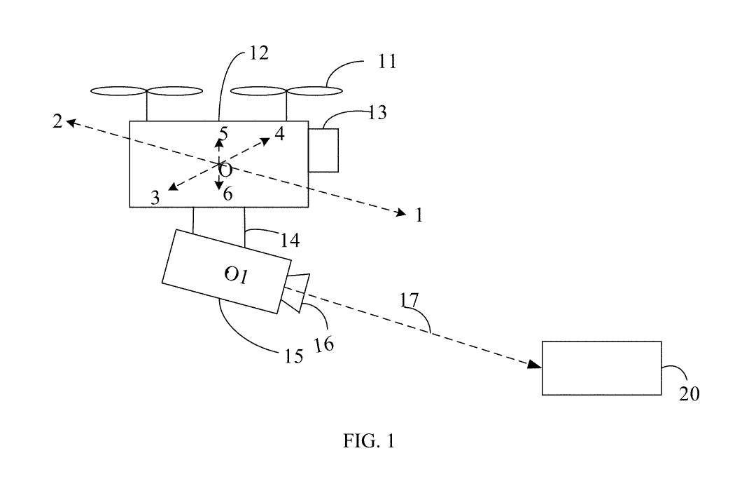

FIG. 1 illustrate a schematic view of an exemplary unmanned aerial vehicle (UAV) and a target object for photographing when the UAV performs aerial photographing. As shown in FIG. 1, the UAV includes propellers 11, a fuselage 12, and a detection device 13. The detection device 13 may be arranged in the front of the UAV, such as at a nose of the UAV. Reference numeral 14 denotes a gimbal of the UAV. The UAV carries a photographing device 15. The photographing device 15 is connected to the fuselage of the UAV through the gimbal 14. The photographing device 15 includes a photographing lens 16. An optical axis direction 17 of the photographing lens 16 points towards a target object 20. The optical axis direction 17 indicates a photographing direction of the photographing lens 16. The target object 20 represents a target object that the photographing lens 16 photographs. The detection device 13 may be configured to sense obstacles around the UAV. The detection device 13 may include at least one of a radar, an ultrasonic wave detection device, a time-of-flight (TOF) distance detection device, a visual detection device, or a laser detection device. A flight controller of the UAV can control the gimbal 14 to rotate. The photographing device 15 can rotate together with the gimbal 14. In some embodiments, the flight controller can control attitude angles of the gimbal 14. The attitude angles may include a pitch angle, a roll angle, and/or a yaw angle. The flight controller may control attitude angles of the photographing devices by controlling the attitude angles of the gimbal 14, such that the photographing device can point towards the target object to be photographed.

In order to achieve a better photographing performance, the target object 20 may need to be photographed from a plurality of different angles. Various approaches may be used to photograph the target object 20 from a plurality of different angles. For example, a center of the UAV fuselage may be kept pointing toward the target object 20. As shown in FIG. 1, letter “O” denotes a center of the UAV fuselage, reference numeral “1” denotes a direction pointing from the center of the UAV fuselage to the target object 20, the optical axis direction 17 of the photographing lens 16 points toward the target object 20. The UAV may be controlled to move under a gimbal coordinate system. The gimbal coordinate system refers to a left-handed coordinate system having the center “O” of the UAV fuselage as an origin. A positive direction of the X-axis of the gimbal coordinate system refers to a direction pointing from the center of the UAV fuselage to the target object 20, i.e., the direction indicated by an arrow 1. A positive direction of the Y-axis refers to a direction indicated by an arrow 3. A positive direction of the Z-axis refers to a direction indicated by an arrow 5. A center O1 of the photographing device 15 is on the Z-axis of the gimbal coordinate system.

If the UAV is controlled to move in the direction indicated by the arrow 1 while the target object 20 is not moving, the photographing lens 16 may approach the target object 20. Taking the target object 20 as a reference, this is equivalent to the photographing lens 16 being zoomed in. If the UAV is controlled to move in the direction indicated by the arrow 2 while the target object 20 is not moving, the photographing lens 16 may move away from the target object 20. Taking the target object 20 as a reference, this is equivalent to the photographing lens 16 being zoomed out. If the UAV is controlled to move in the direction indicated by the arrow 3 while the target object 20 is not moving, the photographing lens 16 may shift to the right relative to the target object 20. If the UAV is controlled to move in the direction indicated by the arrow 4 while the target object 20 is not moving, the photographing lens 16 may shift to the left relative to the target object 20. Thus, by controlling the UAV to move in the directions indicated by the arrow 1, 2, 3 and 4, the target object 20 can be photographed from a plurality of different angles to achieve a better photographing performance. However, the detection device 13 is arranged in the front of the UAV, the detection device is arranged at the nose of the UAV, the detection device 13 may detect only obstacles in front of the UAV. That is, the detection device 13 may detect only obstacles in the direction indicated by the arrow 1, and may not detect obstacles on the left of, on the right of, or behind the UAV. When the UAV is controlled to move in the direction indicated by the arrow 2, the detection device 13 may not detect an obstacle behind the UAV. When the UAV is controlled to move in the direction indicated by the arrow 3, the detection device 13 may not detect an obstacle on the right side of the UAV. When the UAV is controlled to move in the direction indicated by the arrow 4, the detection device 13 may not detect an obstacle on the left side of the UAV. Accordingly, the UAV may crash into an obstacle outside a detection range of the detection device.

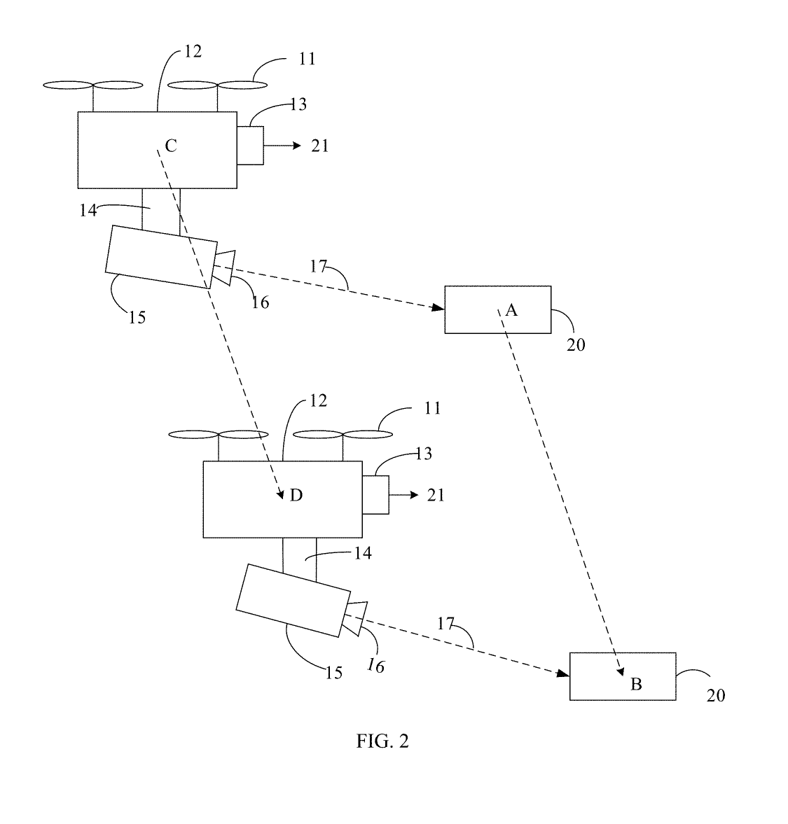

When the target object 20 moves, the UAV can intelligently follow the target object 20. An intelligent follow mode may include a normal tailing mode, a parallel mode, i.e., a parallel following mode, or a locking mode. In the descriptions below, the parallel mode is taken as an example. In the parallel mode, the UAV may follow a movement of the target object 20 on one side of the target object 20 and maintain a relative position to the target object 20. As shown in FIG. 2, it is assumed that the target object 20 moves from position A to position B, in order to maintain the relative position to the target object 20, the UAV moves from position C to position D, and a direction from position A to position B is parallel to a direction from position C to position D. The UAV keeps following the target object 20 on one side. However, during the movement of the UAV from position C to position D, the detection direction 21 of the detection device 13 may not coincide with the movement direction of the UAV, i.e., the direction from the position C to the position D. Thus, during the movement of the UAV from position C to position D, the detection device 13 may detect only obstacles in the detection direction 21, but may not detect an obstacle in the movement direction of the UAV, i.e., an obstacle in the direction from position C to position D. As such, in the parallel following mode, the UAV may collide into one or more obstacles in the movement direction of the UAV, i.e., a moving direction of the UAV.

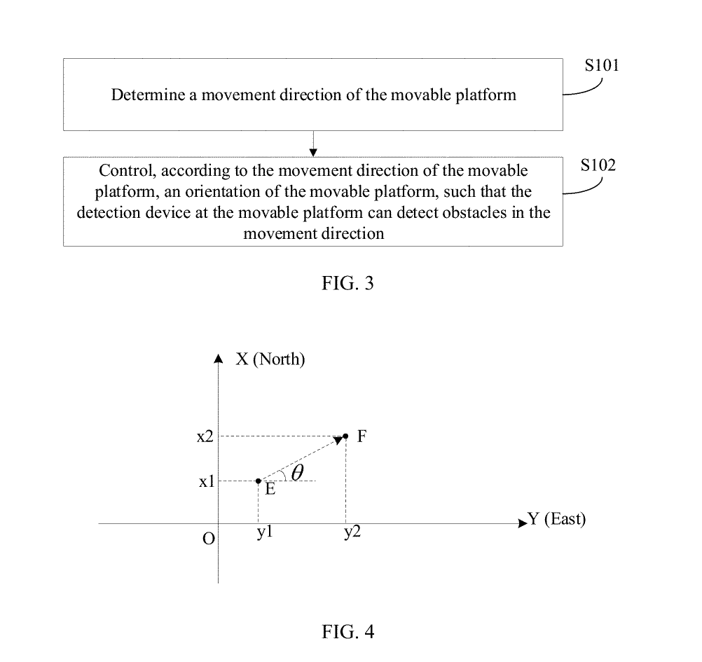

The present disclosure provides a control method. FIG. 3 illustrates a flowchart of an exemplary control method according to various disclosed embodiments of the present disclosure. As shown in FIG. 3, the method may include the processes described below.

At S101, a movement direction of the movable platform is determined.

The movable platform of the present disclosure may include any movable object provided with a detection device for detecting obstacles. One or more UAVs are described below as examples of the movable platform for illustrative purposes. In some embodiments, the movable platform includes a UAV, and an executing entity of the method consistent with the disclosure may include a flight controller of the UAV. The flight controller may obtain data outputted by the UAV's sensor system, i.e., a sensing system, configured to detect, e.g., a position, an acceleration, an angular acceleration, a velocity, a pitch angle, a roll angle, a yaw angle, and/or the like, of the UAV. The sensor system may include one or more motion sensors and/or one or more visual sensors. A motion sensor may include a gyroscope, an accelerometer, an inertial measurement unit, or a global positioning system (GPS). The flight controller may use the sensor system to determine a movement direction of the UAV.

When the UAV performs aerial photographing, the flight controller may determine the movement direction of the UAV according to the sensor system. In some embodiments, the movement direction of the UAV can be determined according to a displacement of the UAV.

In some embodiments, a world coordinate system may be adopted to determine a relative-to-ground (RTG) position of the UAV. Assuming that a flight height of the UAV is known, a plane at the flight height and parallel to the ground can be determined. As shown in FIG. 4, in the plane, a north direction is taken as a positive direction of an X-axis of the world coordinate system, an east direction is taken as a positive direction of a Y-axis of the world coordinate system, and an upward direction perpendicular to the XOY plane is taken as a positive direction of a Z-axis of the world coordinate system. A position change of the UAV is the displacement of the UAV. For example, the UAV moves from position E to position F in the XOY plane of the world coordinate system, correspondingly, the position change from position E to position F is the displacement of the UAV. The displacement is a vector having both a direction (displacement direction) and a magnitude (displacement magnitude). In the example shown in FIG. 4, the displacement magnitude is the distance from position E to position F, and the displacement direction is a direction pointing from position E to position F.

In some embodiments, the movement direction of the UAV in the world coordinate system can be determined according to the displacement of the UAV in the world coordinate system. For example, as shown in FIG. 4, it is assumed that the UAV is located at position E at a preceding time point t1 and is located at position F at a subsequent time point t2. A coordinate of position E in the X-axis direction is x1, and a coordinate of position E in the Y-axis direction is y1. A coordinate of position F in the X-axis direction is x2, and a coordinate of position F in the Y-axis direction is y2. During a movement of the UAV from position E to position F, the displacement of the UAV in the X-axis direction is a position change from x1 to x2, a magnitude of the displacement of the UAV in the X-axis direction is (x2−x1), the displacement of the UAV in the Y-axis direction is a position change from y1 to y2, and a magnitude of the displacement of the UAV in the Y-axis direction is (y2−y1). In some embodiments, a direction pointing from position E to position F can be determined as a movement direction of the UAV at time point t1, and/or a movement direction of the UAV at time point t2. Since the movement direction of the UAV may vary, a movement direction of the UAV after time point t2 or before time point t1 may differ from the direction pointing from position E to position F.

As shown in FIG. 4, it is assumed that an angle between a direction pointing from position E to position F and the positive direction of the Y-axis is θ. According to a magnitude of the displacement (x2−x1) of the UAV in the X-axis direction and a magnitude of the displacement (y2−y1) of the UAV in the Y-axis direction, the angle θ between the direction pointing from position E to position F and the positive direction of the Y-axis may be determined. The relationship among θ, (x2−x1), and (y2−y1) can be determined according to formula (1) described below.

tan θ=(x2−x1)/(y2−y1) (1)

A value of θ may be determined according to formula (2) described below.

θ=arc tan[(x2−x1)/(y2−y1)] (2)

Angle θ is an angle between the movement direction of the UAV and the positive direction of the Y-axis of the world coordinate system during the movement of the UAV from position E to position F. Thus, angle θ can be used to indicate the movement direction of the UAV.

In some other embodiments, the movement direction of the UAV can be determined according to a movement velocity of the UAV, i.e., a moving velocity of the UAV.

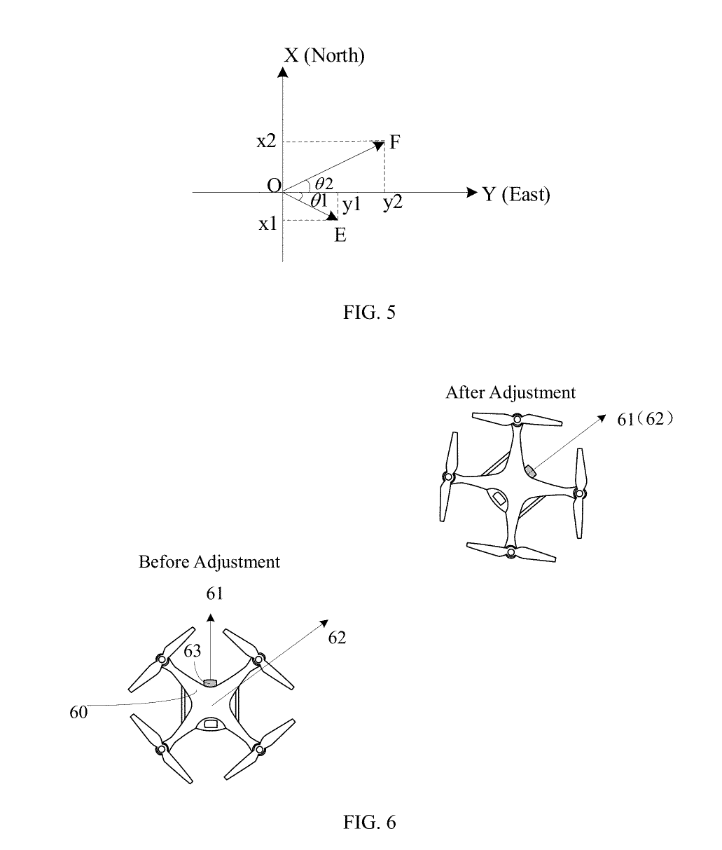

The movement velocity of the UAV is also a vector having both a direction (velocity direction) and a magnitude (velocity magnitude). In some embodiments, the movement velocity of the UAV can include a vector varying in real time. As shown in FIG. 5, OE indicates a movement velocity of the UAV at a preceding time point t1, OF indicates a movement velocity of the UAV at a subsequent time point t2. At time point t1, the movement velocity OE of the UAV has a component x1 on the X-axis of the world coordinate system, and a component y1 on the Y-axis. At time point t2, the movement velocity of the UAV has a component x2 on the X-axis of the world coordinate system, and a component y2 on the Y-axis.

In some embodiments, the movement direction of the UAV may also be determined according to, for example, a ratio of components of the movement velocity of the UAV on the X-axis and on the Y-axis of the world coordinate system. At a momentary time point, it may be assumed that the movement direction of the UAV is consistent with a velocity direction of the UAV, i.e., a direction of the movement velocity of the UAV.

At time point t1, angle θ1 between the movement velocity OE of the UAV and the positive direction of the Y-axis can be used to indicate the movement direction of the UAV at time point t1. Angle θ1 can be determined according to, for example, formula (3) or formula (4) described below.

tan θ1=x1/y1 (3)

θ1=arc tan(x1/y1) (4)

At time point t2, angle θ2 between the movement velocity OF of the UAV and the positive direction of the Y-axis can be used to indicate the movement direction of the UAV at time point t2. Angle θ2 can be determined according to, for example, formula (5) or formula (6) described below.

tan θ2=x2/y2 (5)

θ2=arc tan(x2/y2) (6)

Thus, at time point t1 and time point t2, the movement directions of the UAV may be different. Similarly, at other different time points, movement directions of the UAV may be different.

At S102, according to the movement direction of the movable platform, an orientation of the movable platform is controlled, such that the detection device at the movable platform can detect obstacles in the movement direction.

After the movement direction of the UAV is determined according to the above-described processes, the orientation of the UAV may be controlled according to the movement direction of the UAV. As shown in FIG. 2, the movement direction of the UAV points from C to D, and the detection direction of the detection device remains in the direction indicated by arrow 21. The movement direction of the UAV is inconsistent with the detection direction of the detection device. The flight controller may control the orientation of the UAV according to the movement direction of the UAV, such that the detection direction of the detection device at the nose of the UAV may be consistent with the movement direction of the UAV. That is, the movement direction of the UAV may determine the orientation of the UAV. If the detection direction of the UAV and the movement direction of the UAV are inconsistent, the flight controller can adjust the orientation of the UAV, such that the detection direction of the detection device at the nose of the UAV is consistent with the movement direction of the UAV. As a result, the detection device 13 can detect obstacles in the movement direction CD. In addition, when the flight controller adjusts the orientation of the UAV, the photographing direction of the photographing device 15, i.e., the optical axis direction 17, may still point at the target object 20 for photographing, and following and photographing of the target object 20 may be achieved.

In addition, as shown in FIG. 6, reference numeral 60 denotes a quadrotor UAV, reference numeral 63 denotes a detection device provided at a nose of the UAV 60, reference numeral 61 denotes a detection direction of the detection device, and reference numeral 62 denotes a movement direction of the UAV. Before an orientation of the UAV is adjusted, the detection direction of the detection device is inconsistent with the movement direction of the UAV. Further, the flight controller can control and adjust the orientation of the UAV. After the orientation of the UAV is adjusted, the detection direction 61 of the detection device coincides with the movement direction 62 of the UAV.

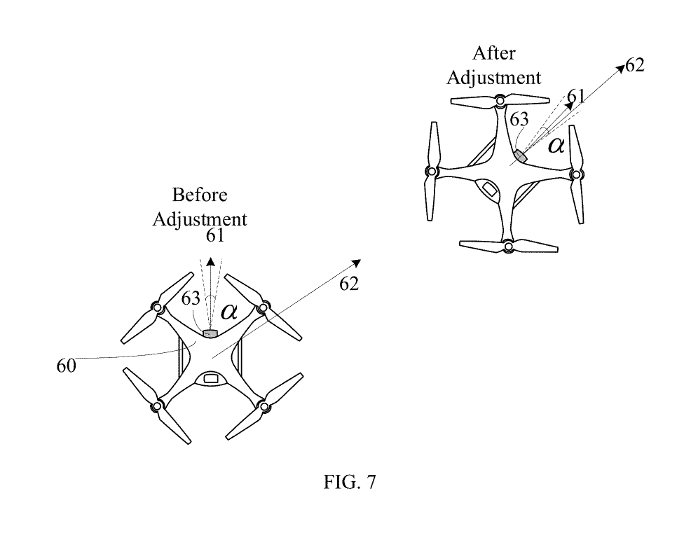

In some other embodiments, such as that shown in FIG. 7, the detection device 63 not only can detect obstacles in a direction indicated by arrow 61, but also can detect obstacles in an angle range a with a direction indicated by arrow 61 as a center. In these embodiments, after the orientation of the UAV is adjusted, the detection direction 61 of the detection device may not need to exactly match the movement direction 62 of the UAV. As long as an angle between the detection direction 61 of the detection device and the movement direction 62 of the UAV is smaller than a, the detection device 63 may be ensured to detect obstacles in the movement direction 62.

In some embodiments, the movement direction of the UAV may be determined, and the orientation of the UAV may be controlled according to the movement direction of the UAV, to ensure that the detection device can detect obstacles in the movement direction, and to prevent possible collisions caused by the detection device being unable to detect obstacles in the movement direction of the UAV when the detection direction of the detection device is inconsistent with the movement direction of the UAV. Accordingly, flight safety of the UAV can be improved.

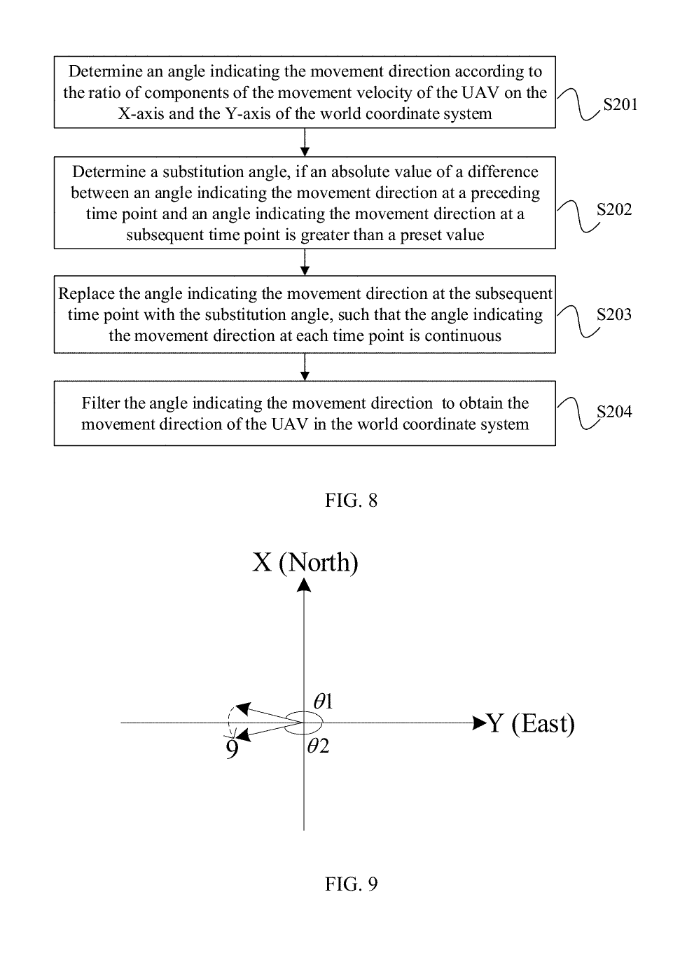

FIG. 8 illustrates a flowchart of another exemplary control method according to various disclosed embodiments of the present disclosure. As shown in FIG. 8, based on examples described in connection with FIG. 3, determining the movement direction of the UAV in the world coordinate system according to the ratio of components of the movement velocity of the UAV on the X-axis and on the Y-axis of the world coordinate system may include processes described below.

At S201, an angle indicating the movement direction is determined according to the ratio of components of the movement velocity of the UAV on the X-axis and the Y-axis of the world coordinate system.

For example, as shown in FIG. 5, at time point t1, an angle indicating the movement direction is an angle of the movement direction with respect to a reference direction. In FIG. 5, the positive direction of the Y-axis is taken as the reference direction. Correspondingly, angle θ1 between the movement velocity OE of the UAV and the positive direction of the Y-axis indicates the movement direction of the UAV at time point t1. At time point t2, angle θ2 between the movement velocity OF of the UAV and the positive direction of the Y-axis indicates the movement direction of the UAV at time point t2. If a counterclockwise rotation from the positive direction of the Y-axis of the world coordinate system to a velocity direction corresponds to a positive direction and a clockwise rotation from the positive direction of the Y-axis of the world coordinate system to a velocity direction corresponds to a negative direction, angle θ1 is a negative angle, and angle θ2 is a positive angle. An angle range covered by a counterclockwise rotation from the positive direction of the Y-axis of the world coordinate system to a negative direction of the Y-axis of the world coordinate system corresponds to a range of the angle of the movement direction of the UAV from approximately 0 degrees to approximately positive 180 degrees. An angle range covered by a clockwise rotation from the positive direction of the Y-axis of the world coordinate system to the negative direction of the Y-axis of the world coordinate system corresponds to a range of the angle of the movement direction of the UAV from approximately 0 degrees to approximately negative 180 degrees. Thus, the range of the angle indicating the movement direction of the UAV is from approximately positive 180 degrees to approximately negative 180 degrees. Selecting the Y-axis as the reference direction is merely for illustrative purposes. Those skilled in the art can select another direction as the reference direction, which is not restricted in the present disclosure. For example, the positive direction of the X-axis may be selected as the reference direction.

In some embodiments, the movement velocity of the UAV detected by the sensor system at the UAV may constantly vary. That is, movement velocities of UAV detected at different time points may be different. According to the methods described in connection with FIG. 5, a movement direction of the UAV at each time point may be determined. That is, the angle indicating the movement direction may be determined according to a ratio of a velocity of the UAV on the X-axis to a velocity of the UAV on the Y-axis of the world coordinate system.

At S202, if an absolute value of a difference between an angle indicating the movement direction at a preceding time point and an angle indicating the movement direction at a subsequent time point is greater than a preset value, a substitution angle is determined.

Because the movement velocity of the UAV may constantly change, the movement velocity of the UAV detected by an inertial measurement unit, a gyroscope, and/or a GPS at the UAV may also constantly change. When the UAV is at a hover status or flies at a relatively low speed, the direction of the movement velocity of the UAV may change relatively fast. As shown in FIG. 9, at a preceding time point t1, angle θ1 indicating the movement direction of the UAV is approximately 170 degrees, and at a subsequent time point t2, angle θ2 indicating the movement direction of the UAV is approximately −170 degrees. A comparison between approximately 170 degrees and approximately −170 degrees may indicate that the movement direction of the UAV has a relatively large change in a short time. That is, a step-type change, i.e., a jump, may have occurred. As a result, the angles indicating the movement direction of the UAV may not be continuous at the preceding time point t1 and the subsequent time point t2.

In some embodiments, a continuation processing may be performed on an angle indicating a movement direction at each time point, according to a difference between the angle indicating the movement direction at the preceding time point and the angle indicating the movement direction at the subsequent time point. For example, at the preceding time point t1, angle θ1 indicating the movement direction of the UAV may be approximately 170 degrees, and at the subsequent time point t2, angle θ2 indicating the movement direction of the UAV may be approximately −170 degrees. An absolute value of the difference between the two angles is approximately 340 degrees. If the preset value is approximately 180 degrees, the angle of approximately 340 degrees is greater than the preset value. Thus, a substitution angle of angle θ2 indicating the movement direction of the UAV may need to be determined for the subsequent time point t2 to replace angle θ2 indicating the movement direction of the UAV at the subsequent time point t2.

As shown in FIG. 9, the UAV may need to change only approximately 20 degrees in a counterclockwise direction from approximately 170 degrees to approximately −170 degrees, and the UAV may need to change approximately 340 degrees in a clockwise direction from approximately 170 degrees to approximately −170 degrees. In a short time period, it is more likely that the UAV changes its movement direction in the counterclockwise direction from the approximately 170 degrees to the approximately −170 degrees than changing the movement direction in the clockwise direction from the approximately 170 degrees to the approximately −170 degrees. To align the orientation of the UAV with the movement direction of the UAV, it is easier to rotate the UAV in the counterclockwise direction than in the clockwise direction. For calculation purposes, in order to obtain stable and continuous movement directions and also to facilitate the filter to perform filtering to ensure a filtering performance, in some embodiments, if an absolute value of a difference between an angle indicating the movement direction at a preceding time point and an angle indicating the movement direction at a subsequent time point is greater than a preset value, a substitution angle may be calculated. The substitution angle may be used to replace the angle indicating the movement direction at the subsequent time point. The method for calculating the substitution angle may include calculating a central angle corresponding to a first minor arc from the movement direction of the UAV at the preceding time point to the movement direction of the UAV at the subsequent time point, and obtaining the substitution angle according to the angle indicating the movement direction at the preceding time point and the central angle.

For example, at the preceding time point t1, angle θ1 indicating a movement direction of the UAV may be approximately 170 degrees, and at the subsequent time point t2, angle θ2 indicating a movement direction of the UAV is approximately −170 degrees. The first minor arc from the movement direction of the UAV at the preceding time point t1 to the movement direction of the UAV at the subsequent time point t2 is indicated by arrow 9. The first minor arc 9 corresponds to a central angle of approximately 20 degrees. The substitution angle of approximately 190 degrees may be obtained by adding approximately 20 degrees to θ1, i.e., approximately 170 degrees. The approximately 190 degrees may be used to replace the approximately −170 degrees. Thus, after rotating counterclockwise from the positive direction of the Y-axis of the world coordinate system to the negative direction of the Y-axis, if the rotation continues in the counterclockwise direction, an angle greater than approximately 180 degrees may be used to indicate the angle for the movement direction of the UAV.

At S203, the angle indicating the movement direction at the subsequent time point is replaced with the substitution angle, such that the angle indicating the movement direction at each time point is continuous.

As shown in FIG. 9, when the angle indicating the movement direction at time point t2, i.e., the subsequent time point t2, is approximately −170 degrees, approximately 190 degrees is used to replace the approximately −170 degrees. That is, the angle of approximately 170 degrees and the angle of approximately 190 degrees are used to represent the direction of the movement velocity of the UAV at the preceding time point t1 and the direction of the movement velocity of the UAV at the subsequent time point t2, respectively. Compared with using the angle of approximately 170 degrees and the angle of approximately −170 degrees to represent the direction of the movement velocity of the UAV at the preceding time point t1 and the direction of the movement velocity of the UAV at the subsequent time point t2, using the angles of approximately 170 degrees and approximately 190 degrees can prevent a jump in the directions of the movement velocities and ensure the continuity of the change of the angles indicating the movement directions of the UAV. Similarly, at other time points, angles indicating the movement directions may be processed according to a method of the disclosure, such as one of the above-described methods, such that angle indicating the movement direction may be continuous at each time.

At S204, the angle indicating the movement direction is filtered to obtain the movement direction of the UAV in the world coordinate system.

Because the sensor system at the UAV may be disturbed by the environment, a relatively large noise interference may exist in the movement velocity of the UAV sensed by the sensor system. In order to suppress the noise interference, in some embodiments, a preset filter may be used to perform filtering on angles indicating the movement directions of the UAV at various time points obtained in the above-described processes. Accordingly, noise interferences in angles indicating the movement directions of the UAV at various times may be filtered out. The preset filter may include, for example, a Kalman filter.

In some other embodiments, if an angle value outputted from the filter is greater than approximately 360 degrees, a remainder value may be obtained by subtracting approximately 360 degrees from the angle value. The remainder value may be used to indicate the angle value, such that the angle value outputted by the filter may be stable. Accordingly, a stable angle value indicating a movement direction of the UAV may be obtained.

In addition, in some other embodiments, if the movement velocity of the UAV is smaller than or equal to a threshold, a current orientation of the UAV may remain constant. If an absolute value of a difference between angle values outputted from the filter for a preceding time point and for a subsequent time point is smaller than or equal to a threshold, an orientation of the UAV at the subsequent time point may be kept constant.

In some embodiments, when an absolute value of a difference between an angle indicating a movement direction of the UAV at a preceding time point and an angle indicating a movement direction of the UAV at a subsequent time point is larger than a preset value, a central angle corresponding to a first minor arc from the movement direction of the UAV at the preceding time point to the movement direction of the UAV at the subsequent time point may be calculated. A substitution angle may be determined according to the angle indicating the movement direction at the preceding time point and the central angle corresponding to the first minor arc. Further, the substitution angle may be used to replace the angle indicating the movement direction at the subsequent time point, thereby achieving a continuation processing on an angle indicating a movement direction at each time point and preventing angles indicating movement directions of the UAV from jumping in a short time period. In addition, by using a preset filter to perform filtering on angles indicating the movement directions of the UAV at various time points, noise interferences in angles indicating the movement directions at various time points may be filtered out, and a detection accuracy of the movement direction of the UAV can be improved.

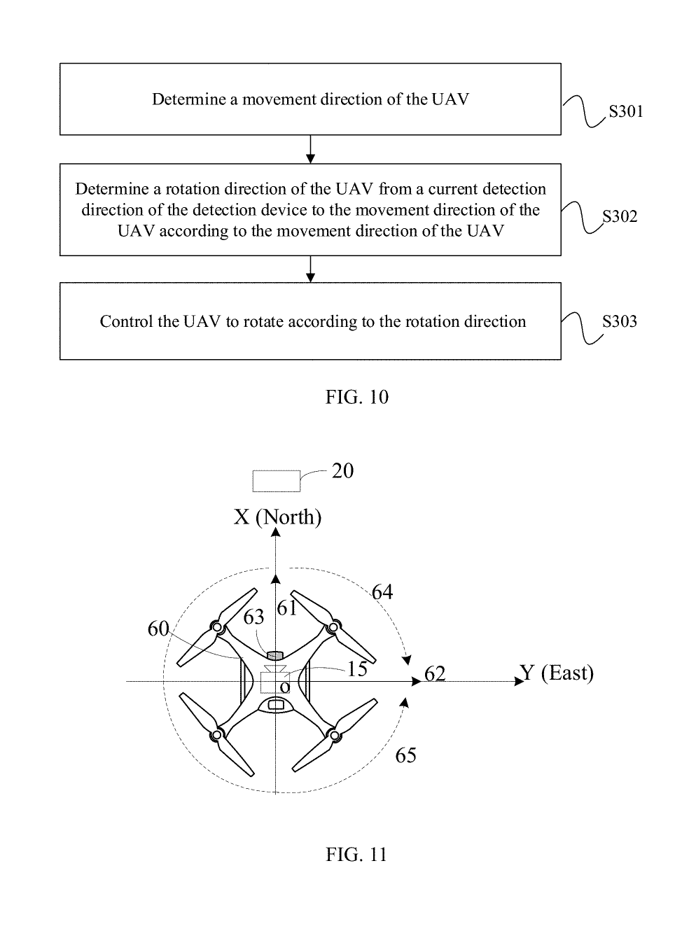

FIG. 10 illustrates a flowchart of another exemplary control method for an UAV according to various disclosed embodiments of the present disclosure. As shown in FIG. 10, on the basis of the examples described in connection with FIG. 3, the method may include the processes described below.

At 301, a movement direction of the UAV is determined.

The process S301 is same as or similar to the process S101, descriptions of which are not repeated here.

At S302, a rotation direction of the UAV from a current detection direction of the detection device to the movement direction of the UAV is determined according to the movement direction of the UAV.

As shown in FIG. 6 or FIG. 7, the flight controller can control the orientation of the UAV according to the movement direction of the UAV. Before the flight controller adjusts the orientation of the UAV, the detection direction of the detection device of the UAV and the movement direction of the UAV is inconsistent. After the flight controller adjusts the orientation of the UAV, the detection direction 61 of the detection device of the UAV is consistent with the movement direction 62 of the UAV, or the angle between the detection direction 61 of the detection device of the UAV and the movement direction 62 of the UAV is smaller than α. Assuming that the movement direction 62 of the UAV remains constant in a short time period, according to FIG. 6, the flight controller can control the orientation of the UAV such that the detecting direction 61 of the detection device is rotated clockwise to the movement direction 62 of the UAV, or the orientation of the UAV can also be controlled such that the detection direction 61 of the detection device is rotated counter-clockwise to the movement direction 62 of the UAV. The method embodiments described below explain how to determine a clockwise or counterclockwise direction for controlling the orientation of the UAV, such that the detection direction 61 of the UAV detection device is consistent with the movement direction 62 of the UAV.

At S303, the UAV is controlled to rotate according to the rotation direction.

After determining the rotation direction of the UAV from the current detection direction of the detection device to the movement direction of the UAV, the flight controller controls the UAV to rotate according to the rotation direction.

In some embodiments, determining the rotation direction of the UAV from the current detection direction of the detection device to the movement direction of the UAV may include processes 41 to 43 described below.

At 41, a second minor arc corresponding to a rotation of the UAV from the current detection direction of the detection device to the movement direction of the UAV is determined according to the movement direction of the UAV and the current detection direction of the detection device.

As shown in FIG. 11, reference numeral 60 denotes a quadrotor UAV, reference numeral 63 denotes a detection device provided at a nose of the UAV 60, reference numeral 61 denotes a detection direction of the detection device 63, reference numeral 62 denotes a movement direction of the UAV, and reference numeral 15 denotes a photographing device carried by the UAV 60. The photographing device 15 is carried by the UAV 60 through a gimbal (not shown). In the present disclosure, a position of the photographing device 15 relative to a fuselage of the UAV 60 is not restricted, and may be selected according to various application scenarios. For example, the photographing device 15 may be arranged at an upper side of the fuselage of the UAV 60, or may be arranged at a lower side of the fuselage of the UAV 60, or may be arranged at another side of the fuselage of the UAV 60.

A center of the fuselage of the UAV 60 is taken as an origin O, an east direction is taken as a positive direction of the Y-axis, and a north direction is taken as a positive direction of the X-axis, to construct a coordinate system as shown in FIG. 11. At time point t3, a target object 20 of the photographing device 15 is directly in front of the UAV 60, and a detection direction 61 of the detection device coincides with the photographing direction of the photographing device 15.

A flight controller of the UAV 60 may adjust the photographing direction of the photographing device 15 by controlling an attitude of the gimbal. The flight controller may control a yaw angle of the gimbal to control the photographing direction of the photographing device 15 to rotate around the yaw axis, i.e., with the yaw axis being a rotation axis. Because the photographing device and the gimbal are connected to each other by transmission lines, the photographing direction of the photographing device 15 cannot rotate around the yaw axis without limit. In some embodiments, stop angles of the yaw axis of the gimbal may be, for example, approximately +360 degrees and approximately −360 degrees. That is, the photographing direction of the photographing device 15 can rotate, for example, only for about one round counterclockwise or about one round clockwise around the yaw axis of the gimbal. A counterclockwise rotation from the positive direction of the X-axis can be set to correspond to a negative direction and a clockwise rotation from the positive direction of the X-axis can be set to correspond to a positive direction. In the coordinate system shown in FIG. 11, the yaw axis of the gimbal is a line passing through the origin O and perpendicular to the XOY plane. Correspondingly, the photographing direction of the photographing device 15 may be rotated counterclockwise for one round from the positive direction of the X-axis, i.e., approximately 0 degree, to return to the positive direction of the X-axis, i.e., approximately −360 degrees, or may be rotated clockwise for one round from the positive direction of the X-axis, i.e., 0 degree, to return to the positive direction of the X-axis, i.e., approximately +360 degrees.

As shown in FIG. 11, the detection direction 61 of the detection device coincides with the positive direction of the X-axis, and the movement direction 62 of the UAV coincides with the positive direction of the Y-axis. Controlling the UAV 60 to rotate from the detection direction 61 of the detection device to the movement direction 62 of the UAV may include two approaches described below. A first approach may include rotating in a clockwise direction, i.e., a direction of a second minor arc 64 for rotating from the detection direction 61 of the detection device to the movement direction 62 of the UAV, where the second minor arc 64 may be different from the first minor arc 9 in the above-described embodiments. A minor arc refers to a circular arc with a central angle smaller than 180 degrees. A second approach may include rotating in a counterclockwise direction, i.e., a direction of a major arc 65 for rotating from the detection direction 61 of the detection device to the movement direction 62 of the UAV. A major arc refers to a circular arc with a central angle larger than 180 degrees.

In order to determine whether it is proper for the UAV to rotate from the current detection direction of the detection device to the movement direction along the direction indicated by the second minor arc, at 42, a rotation angle of the photographing direction of the photographing device at the gimbal of the UAV relative to the detection direction of the detection device is determined. In some embodiments, the photographing direction rotates relative to the detection direction around the yaw axis of the gimbal.

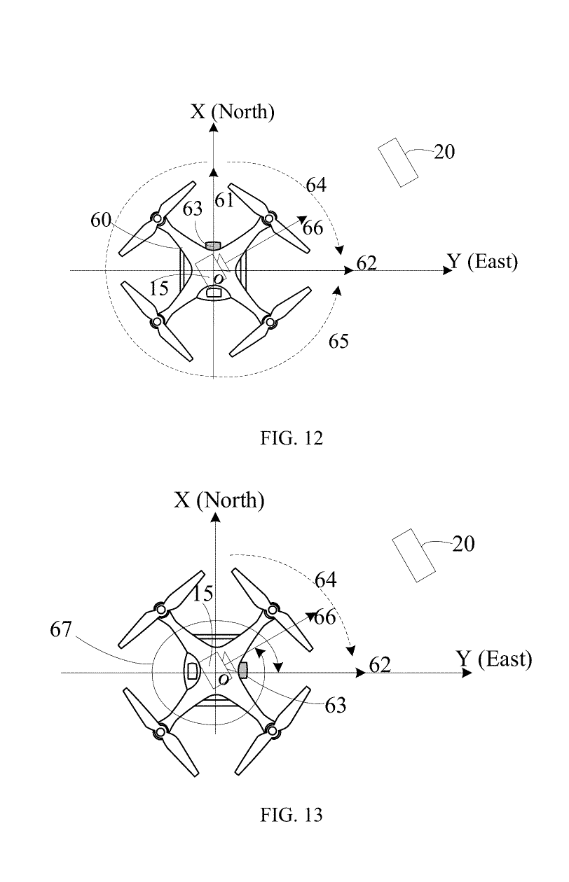

In some embodiments, when a position of the target object 20 changes, the photographing direction of the photographing device 15 may change correspondingly. For example, the target object 20 begins to move in the counterclockwise direction at time point t3, and the target object 20 moves to a position shown in FIG. 12 at time point t4. During the movement of the target object 20 in the counterclockwise direction, the gimbal controls the photographing device 15 to rotate counterclockwise to a direction of approximately −330 degrees as shown in FIG. 12. Reference numeral 66 denotes a photographing direction of the photographing device 15 at time point t4. Correspondingly, the photographing direction 66 of the photographing device 15 rotates for approximately −330 degrees relative to the detection direction 61 of the detection device 63, taking the yaw axis of the gimbal as a rotation axis.

In addition, as shown in FIG. 12, if the gimbal controls the photographing device 15 to continue to rotate approximately 60 degrees counterclockwise, the gimbal will reach a stop angle of its yaw axis, i.e., approximately −360 degrees. If the UAV rotates from the detection direction 61 of the detection device to the movement direction 62 in a direction indicated by the minor arc 64, it may cause the gimbal to more quickly reach the stop angle of the yaw axis, i.e., approximately −360 degrees. Thus, when the rotation direction for the UAV to rotate from the detection direction 61 of the detection device to the movement direction 62 of the UAV is determined, a rotation angle of the photographing direction of the photographing device at the gimbal of the UAV relative to the detection direction of the detection device may need to be taken into account. The photographing direction rotates relative to the detection direction around the yaw axis of the gimbal.

A mechanical angle of the gimbal may refer to a rotation angle relative to a reference direction taking the yaw axis of the gimbal as a rotation axis. The reference direction may include the detection direction of the detection device when the detection direction of the detection device of the UAV is same as or close to the photographing direction of the photographing device. As shown in FIG. 11, the detection direction of the detection device 63 and the photographing direction of the photographing device 15 both are the positive direction of the X-axis. Thus, the positive direction of the X-axis can be used as the reference direction. As shown in FIG. 12, with the yaw axis of the gimbal as a rotation axis, the rotation angle of the photographing device 15 relative to the reference direction, i.e., the positive direction of the X-axis, is approximately −330 degrees. Correspondingly, the mechanical angle of the gimbal is approximately −330 degrees.

Denoting the mechanical angle of the gimbal as β1, and denoting a rotation angle of the UAV in a direction indicated by a minor arc from the current detection direction of the detection device to the movement direction as β2, if |β1−β2| is larger than the stop angle of the yaw axis of the gimbal, it may indicate that the gimbal may reach the stop angle of the yaw axis more quickly if the UAV rotates in the direction indicated by the minor arc from the current detection direction of the detection device to the movement direction. That is, after the UAV rotates in the direction indicated by the minor arc from the current detection direction of the detection device to the movement direction with the yaw axis of the gimbal as a rotation axis, a rotation angle of the photographing direction of the photographing device relative to the detection direction of the detection device will be larger than the stop angle of the yaw axis.

If |β1−β2| is smaller than the stop angle of the yaw axis of the gimbal, it may indicate that the gimbal may reach the stop angle of the yaw axis more slowly if the UAV rotates in the direction indicated by the minor arc from the current detection direction of the detection device to the movement direction. That is, after the UAV rotates in the direction indicated by the minor arc from the current detection direction of the detection device to the movement direction with the yaw axis of the gimbal as a rotation axis, a rotation angle of the photographing direction of the photographing device relative to the detection direction of the detection device will be smaller than the stop angle of the Yaw axis.

At 43, a rotation direction of the UAV is determined according to the rotation angle.

In some embodiments, the rotation direction of the UAV may include at least one of a direction indicated by the second minor arc or a direction indicated by a major arc corresponding to the second minor arc, i.e., a major arc that can form a complete circle with the second minor arc.

For example, if, with the yaw axis of the gimbal as a rotation axis, a rotation angle of the photographing direction of the photographing device at the gimbal of the UAV relative to the detection direction of the detection device is larger than the stop angle of the yaw axis of the gimbal, it may be determined that the rotation direction of the UAV is the direction indicated by the major arc.

As shown in FIG. 12, the mechanical angle β1 of the gimbal is approximately −330 degrees. The rotation angle of the UAV in the direction indicated by the minor arc 64 from the detection direction 61 of the detection device to the movement direction 62 is approximately +90 degrees. Approximately, |β1−⊕2|=|−330−90|=420, and 420 is greater than 360. As shown in FIG. 13, after the UAV rotates in the direction indicated by the minor arc 64 from the detection direction 61 of the detection device to the movement direction 62 with the yaw axis of the gimbal as a rotation axis, the rotation angle of the photographing direction of the photographing device relative to the detection direction of the detection device 63 is approximately −420 degrees, i.e., (−330−90) degrees. As shown in FIG. 13, the rotation angle of approximately −420 degrees exceeds the stop angle of the yaw axis of the gimbal, i.e., approximately −360 degrees.

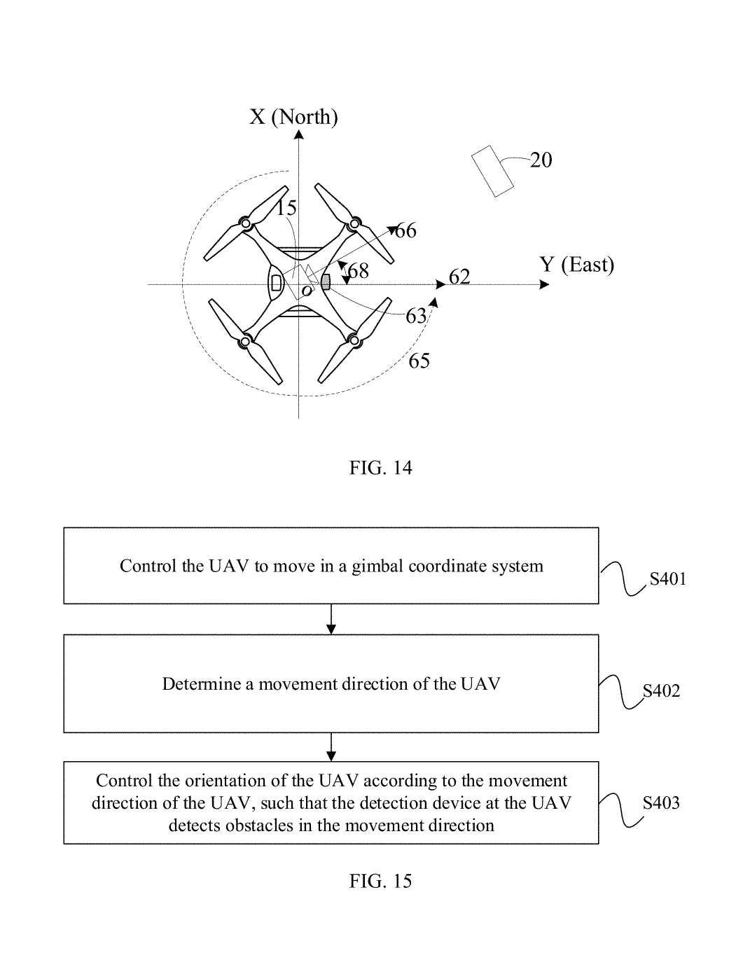

Thus, in the scenario shown in FIG. 12, the flight controller may control the UAV 60 to rotate from the detection direction 61 of the detection device to the movement direction 62 in the direction indicated by the major arc 65. A rotation angle of the UAV 60 in the direction indicated by the major arc 65 from the detection direction 61 of the detection device to the movement direction 62 is approximately −270 degrees. |β1−β2|=|−330−(−270)|=60, and 60 is smaller than 360. Further, as shown in FIG. 14, after the UAV 60 rotates in the direction indicated by the major arc 65 from the detection direction 61 of the detection device to the movement direction 62 with the yaw axis of the gimbal as a rotation axis, the rotation angle of the photographing direction of the photographing device relative to the detection direction of the detection device 63 is approximately −60 degrees, i.e., [−330−(−270)] degrees. As shown in FIG. 14, the rotation angle 68 does not exceed the stop angle of the yaw axis of the gimbal, i.e., approximately −360 degrees.

Similarly, if, with the yaw axis of the gimbal as a rotation axis, a rotation angle of the photographing direction of the photographing device at the gimbal of the UAV relative to the detection direction of the detection device is smaller than or equal to the stop angle of the yaw axis of the gimbal, it is determined that the rotation direction of UAV is the direction indicated by the second minor arc. Detail descriptions are not repeated here.

In some other embodiments, a rotation speed of the UAV may also be determined according to the movement direction of the UAV and the current detection direction of the detection device.

After the movement direction of the UAV, the current detection direction of the detection device, and the rotation direction of the UAV are determined according to one of the above-described methods, a proportion-integral-derivative (PID) controller may be used to control an orientation of the UAV. Inputs of the PID controller may include the movement direction of the UAV (i.e., an expectation angle) and the current detection direction of the detection device (i.e., a current angle), and outputs of the PID controller may include a rotation direction and a rotation speed of the UAV.

In some embodiments, according to the movement direction of the UAV and the current detection direction of the detection device, a minor arc corresponding to the UAV rotating from the current detection direction of the detection device to the movement direction of the UAV may be determined. If a rotation of the UAV, in a direction indicated by the minor arc, from the current detection direction of the detection device to the movement direction will result in a rotation angle of the photographing direction of the photographing device, about the yaw axis of the gimbal, relative to the detection direction of the detection device larger than a stop angle of the yaw axis, then a direction indicated by the major arc is determined as the rotation direction of the UAV. On the other hand, if the rotation of the UAV, in a direction indicated by the minor arc, from the current detection direction of the detection device to the movement direction will result in a rotation angle of the photographing direction of the photographing device, about the yaw axis of the gimbal, relative to the detection direction of the detection device smaller than or equal to the stop angle of the yaw axis, then the direction indicated by the minor arc is determined as the rotation direction of the UAV. As such, the rotation direction of the UAV can be determined. The gimbal can be prevented from reaching the stop angle of the yaw axis, i.e., the yaw direction, when the UAV rotates from the current detection direction of the detection device to the movement direction of the UAV. As such, the rotation angle of the gimbal in the yaw direction remains within a range of the stop angle(s) of the yaw axis. Accordingly, failure of the gimbal and the photographing device may be avoided.

FIG. 15 illustrates a flowchart of another exemplary control method according to various disclosed embodiments of the present disclosure. As shown in FIG. 15, on the basis of the examples described in connection with FIG. 3, the method includes processes described below.

At S401, the UAV is controlled to move in a gimbal coordinate system.

On the basis of the above-described examples, a ground-based controller such as a remote controller can control the UAV movement. A flight controller of the UAV (which may be onboard the UAV) can also control the UAV movement. In some embodiments, the ground-based controller or the flight controller can control the UAV to move in the gimbal coordinate system. In the gimbal coordinate system, a center of the fuselage of the UAV may serve as an origin, and a positive direction of an X-axis may be a direction pointing from the center of the fuselage of the UAV to the target object to be photographed. The gimbal coordinate system may include a left-hand coordinate system. For example, the gimbal coordinate system may be the coordinate system shown in FIG. 1. As shown in FIG. 1, the origin of the gimbal coordinate system is “O”, the positive direction of the X-axis is the direction indicated by arrow 1, a positive direction of the Y-axis is the direction indicated by arrow 3, and a positive direction of the Z-axis is the direction indicated by arrow 5.

When the flight controller of the UAV controls, e.g., autonomously controls, the UAV to move in the gimbal coordinate system, the flight controller can control the UAV to move in the X-axis direction in the gimbal coordinate system; and/or can control the UAV to move in the Y-axis direction in the gimbal coordinate system; and/or can control the UAV to move in the Z-axis direction in the gimbal coordinate system; and/or can control the UAV to rotate around the Z-axis as a rotation axis in the gimbal coordinate system.

When the ground-based controller such as the remote controller controls the UAV to move in the gimbal coordinate system, an operator of the remote controller may control the UAV to move in the gimbal coordinate system by controlling rockers on the remote controller. A sensor may be provided at a bottom of a rocker of the remote controller. The sensor may be configured to detect a control amount of the rocker from the remote controller when the operator operates the rocker. A wireless transmission circuit of the remote controller may send the control amount of the rocker to the flight controller of the UAV. The flight controller may control the UAV to move according to the control amount of the rocker. In some embodiments, the flight controller may be configured to perform at least one of receiving a control amount of a pitch rod or a pitch key of a controller, e.g., a remote controller, and controlling the UAV to move in the X-axis direction in the gimbal coordinate system; receiving a control amount of a roll rod or a roll key of the controller and controlling the UAV to move in the Y-axis direction in the gimbal coordinate system; receiving a control amount of a throttle rod or a throttle key of the controller and controlling the UAV to move in the Z-axis direction in the gimbal coordinate system; or receiving a control amount of a yaw rod or a yaw key of the controller and controlling the UAV to rotate around the Z-axis as a rotation axis in the gimbal coordinate system.

At S402, a movement direction of the UAV is determined.

Process S402 is same as or similar to process S101, descriptions of which are not repeated here.

At S403, the orientation of the UAV is controlled according to the movement direction of the UAV, such that the detection device at the UAV detects obstacles in the movement direction.

Process S403 is same as or similar to process S102, detail descriptions of which are not repeated here.

In some embodiments, a ground-based controller may be used to control the UAV to move in the gimbal coordinate system, or a flight controller may be used to control the UAV to move in the gimbal coordinate system. The UAV may be controlled to move along the positive direction of the X-axis of the gimbal coordinate system, and correspondingly the photographing lens may be moved closer to the target object. The UAV may be controlled to move along the negative direction of the X-axis of the gimbal coordinate system, and correspondingly the photographing lens may be moved away from the target object. The UAV may be controlled to move along the positive direction of the Y-axis of the gimbal coordinate system, and correspondingly the photographing lens may be moved to the right. The UAV may be controlled to move along the negative direction of the Y-axis of the gimbal coordinate system, and correspondingly the photographing lens may be moved to the left. Accordingly, the target object may be photographed from various different angles to achieve a relatively better photographing performance.

The present disclosure provides a control method. Based on the examples described in connection with FIG. 3, the method may further include controlling an attitude of the gimbal at the UAV, such that the photographing device at the gimbal tracks and photographs the target object.

After the flight controller determines the movement direction of the UAV, the UAV can control the detection direction of the detection device to coincide with the movement direction. Further, the flight controller can also control the gimbal of the UAV, such that the photographing device at the gimbal may remain aimed at the target object, i.e., tracking and photographing the target object. When the target object moves, the flight controller may adjust the gimbal to rotate the photographing device, such that the target object may remain in a photographing view of the photographing device. Thus, the UAV not only can detect obstacles in the movement direction, but also can track and photograph the target object. The operational safety of the UAV can be improved. In addition, requirements on professionality of the user may be reduced.

The present disclosure also provides a computer storage medium having program instructions stored therein. The program instructions, when executed, can perform part or all of processes of a control method consistent with the disclosure, such as one of the control methods described above in connection with FIGS. 3-15.

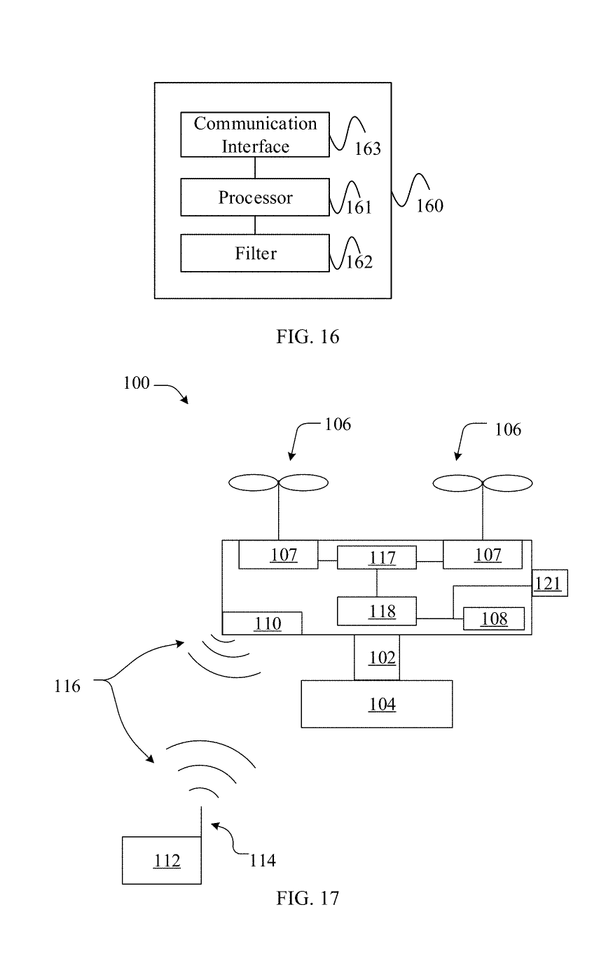

The present disclosure provides a control device. FIG. 16 illustrates a block diagram of an exemplary control device according to various disclosed embodiments of the present disclosure. As shown in FIG. 16, the control device includes one or more processors 161. The one or more processors 161 may work individually or work collaboratively. The one or more processors 161 may be configured to determine a movement direction of a movable platform and to control an orientation of the movable platform according to the movement direction of the movable platform, such that a detection device at the movable platform may detect obstacles in the movement direction.

The movable platform of the present disclosure may include any movable object provided with a detection device for detecting obstacles. A UAV is used as an exemplary movable platform merely for illustrative purposes in the descriptions below. In some embodiments, the movable platform includes a UAV, and the processor 161 may be configured to determine the movement direction of the UAV by various approaches.

In some embodiments, the processor 161 can determine the movement direction of the UAV according to a displacement of the UAV.

The processor may determine the movement direction of the UAV in the world coordinate system according to a displacement of the UAV in the world coordinate system. In some embodiments, the processor may determine the movement direction of the UAV in the world coordinate system according to a displacement of the UAV in an X-axis direction and a displacement of the UAV in a Y-axis direction in the world coordinate system.

In some other embodiments, the processor 161 can determine the movement direction of the UAV according to a movement velocity of the UAV.

The processor may determine the movement direction of the UAV in the world coordinate system according to velocities of the UAV in the X-axis direction and in the Y-axis direction in the world coordinate system. In some embodiments, the processor may determine the movement direction of the UAV in the world coordinate system according to a ratio of movement velocities of the UAV in the X-axis direction and in the Y-axis direction in the world coordinate system. That is, the processor may determine the movement direction of the UAV in the world coordinate system according to a ratio of components of a movement velocity of the UAV in the X-axis direction and in the Y-axis direction in the world coordinate system.

In some embodiments, the principles and implementation manners of the control device are similar to examples described in connection with FIG. 3, descriptions of which are not repeated here.

In some embodiment, the movement direction of the movable platform may be determined, and the orientation of the movable platform may be controlled according to the movement direction of the movable platform, to ensure that the detection device can detect obstacles in the movement direction, and to prevent possible collisions resulting from the detection device being unable to detect obstacles in the movement direction of the movable platform when the detection direction of the detection device is inconsistent with the movement direction of the movable platform. Accordingly, operation safety of the movable platform can be improved.

In some embodiments, as shown in FIG. 16, the control device 160 further includes a filter 162 communicatively coupled to the processor 161. To determine the movement direction of the UAV in the world coordinate system according to the ratio of the movement velocities of the UAV in the X-axis direction and in the Y-axis direction in the world coordinate system, the processor 161 can determine an angle that indicates the movement direction according to the ratio of the movement velocities of the UAV in the X-axis direction and in the Y-axis direction in the world coordinate system, and the filter 162 can filter the angle indicating the movement direction to obtain the movement direction of the UAV in the world coordinate system. That is, the filter 162 may be configured to filter the angle indicating the movement direction to obtain the movement direction of the UAV in the world coordinate system.

In some embodiments, before the filter 162 filters the angle indicating the movement direction, the processor 161 can calculate a difference between an angle indicating the movement direction at a preceding time point and an angle indicating the movement direction at a subsequent time point, and to compare an absolute value of the difference between the angle indicating the movement direction at the preceding time point and the angle indicating the movement direction at the subsequent time point with a preset value. If the absolute value of the difference between the angle indicating the movement direction at the preceding time point and the angle indicating the movement direction at the subsequent time point is greater than the preset value, the processor 161 can determine a substitution angle and replace the angle indicating the movement direction at the subsequent time point with the substitution angle to ensure an angle indicating the movement direction is continuous at each time point. The angle indicating the movement direction may include an angle of the movement direction relative to a reference direction.

In some embodiments, to determine the substitution angle, the processor 161 can determine a first minor arc corresponding to a rotation from the movement direction of the UAV at the preceding time point to the movement direction of the UAV at the subsequent time point and determine the substitution angle according to the angle indicating the movement direction at the preceding time point and a central angle corresponding to the first minor arc.

In some embodiments, the principles and implementation manners of the control device are similar to the examples described in connection with FIG. 8, descriptions of which are not repeated here.

In some embodiments, when an absolute value of a difference between an angle value indicating a movement direction of the UAV at a preceding time point and an angle value indicating a movement direction of the UAV at a subsequent time point is larger than a preset value, a central angle corresponding to a minor arc from the movement direction of the UAV at the preceding time point to the movement direction of the UAV at the subsequent time point may be calculated. A substitution angle may be determined according to the angle indicating the movement direction at the preceding time point and the central angle corresponding to the minor arc. Further, the substitution angle may be used to replace the angle indicating the movement direction of the subsequent time point, thereby achieving a continuation processing on angles indicating movement directions at various time points and preventing angles indicating movement directions of the UAV from jumping in a short time period. In addition, a preset filter may be used to filter angles indicating the movement directions of the UAV at various time points. Accordingly, noise interferences in angles indicating the movement directions at various time points may be filtered out, and a detection accuracy of the movement direction of the UAV can be improved.

In some embodiments, the processor 161 can control the detection direction of the detection device to be consistent with the movement direction of the UAV.

In some embodiments, the processor 161 can control the orientation of the UAV by determining a rotation direction of the UAV from a current detection direction of the detection device to a movement direction of the UA, and controlling the UAV to rotate according to the rotation direction.

In some embodiments, to determine the rotation direction of the UAV from the current detection direction of the detection device to the movement direction of the UAV, the processor 161 can determine a second minor arc corresponding to a rotation of the UAV from the current detection direction of the detection device to the movement direction of the UA according to the movement direction of the UAV and the current detection direction of the detection device; determine a rotation angle of the photographing direction of the photographing device at the gimbal of the UAV relative to the detection direction of the detection device, where the UAV rotates relative to the detection direction around the yaw axis of the gimbal; and determine a rotation direction of the UAV according to the rotation angle of the photographing direction of the photographing device relative to the direction of the detection device. The rotation direction of the UAV may include at least one of a direction indicated by the second minor arc or a direction indicated by a major arc corresponding to the second minor arc.

In some embodiments, to determine the rotation direction of the UAV according to the rotation angle, the processor 161 can compare the rotation angle with a stop angle of the Yaw axis of the gimbal, and determine the direction indicated by the major arc as the rotation direction of the UAV if the rotation angle is larger than the stop angle of the Yaw axis of the gimbal or determine the direction indicated by the second minor arc as the rotation direction of the UAV if the rotation angle is smaller than or equal to the stop angle of the Yaw axis of the gimbal.

In some other embodiments, the processor 161 is further configured to determine a rotation speed of the UAV according to the movement direction of the UAV and the current detection direction of the detection device. The detection device may include at least one of a radar, an ultrasonic wave detection device, a time-of-flight (TOF) distance detection device, a visual detection device, or a laser detection device.

In some embodiments, the principles and implementation manners of the control device are similar to examples described in connection with FIG. 10, descriptions of which are not repeated here.

In some embodiments, according to the movement direction of the UAV and the current detection direction of the detection device, a minor arc corresponding to the UAV rotating from the current detection direction of the detection device to the movement direction of the UAV may be determined. If a rotation of the UAV, in a direction indicated by the minor arc, from the current detection direction of the detection device to the movement direction will result in a rotation angle of the photographing direction of the photographing device, about the yaw axis of the gimbal, relative to the detection direction of the detection device larger than a stop angle of the yaw axis, then a direction indicated by the major arc is determined as the rotation direction of the UAV. On the other hand, if the rotation of the UAV, in a direction indicated by the minor arc, from the current detection direction of the detection device to the movement direction will result in a rotation angle of the photographing direction of the photographing device, about the yaw axis of the gimbal, relative to the detection direction of the detection device smaller than or equal to the stop angle of the yaw axis, then the direction indicated by the minor arc is determined as the rotation direction of the UAV. As such, the rotation direction of the UAV can be determined. The gimbal can be prevented from reaching the stop angle of the yaw axis, i.e., the yaw direction, when the UAV rotates from the current detection direction of the detection device to the movement direction of the UAV. As such, the rotation angle of the gimbal in the yaw direction remains within a range of the stop angle(s) of the yaw axis. Accordingly, failure of the gimbal and the photographing device may be avoided.

In some embodiments, the processor 161 is further configured to control the UAV to move in a gimbal coordinate system. In the gimbal coordinate system, a center of the fuselage of the UAV may serve as an origin, and a positive direction of an X-axis may be a direction pointing from the center of the fuselage of the UAV to a target object for photographing. The gimbal coordinate system may be a left-hand coordinate system.

In some embodiments, the control device 160 further includes a communication interface 163 communicatively coupled to the processor 161. The communication interface 163 may be configured to receive a control amount of the controller, and transmit the control lever of the controller to the processor 161. The processor 161 may control, according to the control amount of the controller, the UAV to move in the gimbal coordinate system.

To control the UAV to move in the gimbal coordinate system, the processor 161 can perform at least one of controlling the UAV to move in the X-axis direction in the gimbal coordinate system; controlling the UAV to move in the Y-axis direction in the gimbal coordinate system; controlling the UAV to move in the Z-axis direction in the gimbal coordinate system; or controlling the UAV to rotate around the Z-axis in the gimbal coordinate system.

In some embodiments, the communication interface 163 may be configured to receive at least one of: a control amount of a pitch rod or a pitch key of the controller, a control amount of a roll rod or a roll key of the controller, a control amount of a throttle rod or a throttle key of the controller, or a control amount of a yaw rod or a yaw key of the controller. Correspondingly, the processor 161 may be configured to perform at least one of: controlling the UAV to move in the X-axis direction in the gimbal coordinate system according to the control amount of the pitch rod or the pitch key of the controller; controlling the UAV to move in the Y-axis direction in the gimbal coordinate system according to the control amount of the roll rod or the roll key of the controller; controlling the UAV to move in the Z-axis direction in the gimbal coordinate system according to the control amount of the throttle rod or the throttle key of the controller; or controlling the UAV to rotate around the Z-axis in the gimbal coordinate system according to the control amount of the yaw rod or the yaw key of the controller.

In some embodiments, the processor 161 may be further configured to control an attitude of the gimbal of the UAV, such that the photographing device at the gimbal tracks and photographs the target object.

In some embodiments, the principles and implementation manners of the control device are similar to examples described in connection with FIG. 15, descriptions of which are not repeated here.

In some embodiments, a ground-based controller may control the UAV to move in the gimbal coordinate system, or a flight controller may control the UAV to move in the gimbal coordinate system. The UAV may be controlled to move along the positive direction of the X-axis of the gimbal coordinate system, and correspondingly the photographing lens may be moved closer to the target object. The UAV may be controlled to move along the negative direction of the X-axis of the gimbal coordinate system, and correspondingly the photographing lens may be moved away from the target object. The UAV may be controlled to move along the positive direction of the Y-axis of the gimbal coordinate system, and correspondingly the photographing lens may be moved to the right. The UAV may be controlled to move along the negative direction of the Y-axis of the gimbal coordinate system, and correspondingly the photographing lens may be moved to the left. Thus, the target object may be photographed from various angles to achieve a relatively better photographing performance.

The present disclosure provides a movable platform. The movable platform of the present disclosure may include any movable object provided with a detection device for detecting obstacles. A UAV is used as an exemplary movable platform merely for illustrative purposes in the descriptions below. FIG. 17 illustrates a schematic view of an exemplary UAV 100 according to various disclosed embodiments of the present disclosure. As shown in FIG. 17, the UAV 100 includes a fuselage, a power system, a control device 118, and a detection device 121. The power system may include at least one of a motor 107, a propeller 106, or an electronic speed regulator 117. The power system is installed at the fuselage for providing power. The detection device 121 is installed at the fuselage and communicatively coupled to the control device 118 and is used for detecting objects in front of the UAV. The control device 118 is communicatively coupled to the power system and is used for controlling the UAV 100 to fly. The control device 118 may include an inertial measurement circuit and/or a gyroscope. The inertial measurement circuit and the gyroscope may be configured to detect an acceleration, a pitch angle, a roll angle, a yaw angle of the UAV, and/or the like.

In some embodiments, as shown in FIG. 17, the UAV 100 further includes a sensing system 108, a communication system 110, a supporting device 102, and a photographing device 104. The supporting device 102 may include, for example, a gimbal. The communication system 110 may include, for example, a receiver for receiving a wireless signal transmitted from, e.g., an antenna 114 of a ground station 112. Reference numeral 116 indicates an electromagnetic wave generated during communication between the receiver and the antenna 114.

In some embodiments, the principles and implementation manners of the control device are similar to above-described examples, descriptions of which are not repeated here.

In some embodiment, a movement direction of the movable platform may be determined, and the orientation of the movable platform may be controlled according to the movement direction of the movable platform, to ensure that the detection device can detect obstacles in the movement direction, and to prevent possible collisions resulting from the detection device being unable to detect obstacles in the movement direction of the movable platform when the detection direction of the detection device is inconsistent with the movement direction of the movable platform. Accordingly, operation safety of the movable platform can be improved.

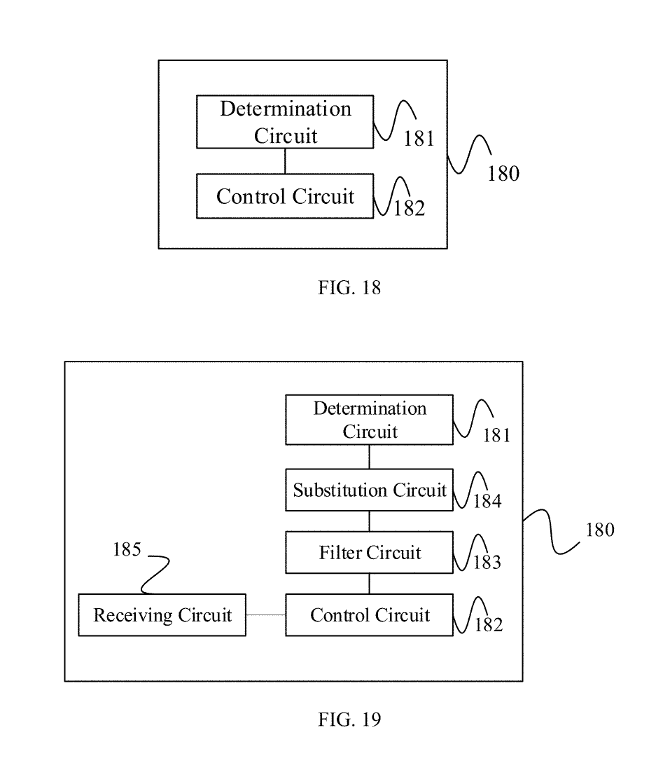

The present disclosure provides a control apparatus. FIG. 18 illustrates a block diagram of an exemplary control apparatus 180 according to various disclosed embodiments of the present disclosure. As shown in FIG. 18, the control apparatus 180 includes a determination circuit 181 and a control circuit 182. The determination circuit 181 may be configured to determine a movement direction of the movable platform. The control circuit 182 may be configured to control an orientation of the movable platform according to the movement direction of the movable platform, such that a detection device at the movable platform can detect obstacles in the movement direction. The detection device may include at least one of a radar, an ultrasonic wave detection device, a time-of-flight (TOF) distance detection device, a visual detection device, or a laser detection device.

The movable platform of the present disclosure may include any movable object provided with a detection device for detecting obstacles. A UAV is used as an exemplary movable platform merely for illustrative purposes in the descriptions below. In the embodiments that the movable platform includes a UAV, the determination circuit 181 may be configured to determine a movement direction of the UAV according to a displacement of the UAV. In some embodiments, the determination circuit 181 may be configured to determine a movement direction of the UAV according to a movement velocity of the UAV.

To determine the movement direction of the UAV according to the displacement of the UAV, the determination circuit 181 may determine a movement direction of the UAV in a world coordinate system according to a displacement of the UAV in the world coordinate system. In some embodiments, the movement direction of the UAV in the world coordinate system may be determined according to the displacements of the UAV in an X-axis direction and a Y-axis direction in the world coordinate system.

To determine the movement direction of the UAV according to the movement velocity of the UAV, the determining circuit 181 may determine the movement direction of the UAV in the world coordinate system according to the movement velocities of the UAV in an X-axis direction and a Y-axis direction in the world coordinate system. In some embodiments, the movement direction of the UAV in the world coordinate system may be determined according to a ratio of the movement velocities of the UAV in the X-axis direction and the Y-axis direction in the world coordinate system.

In some embodiments, the principles and implementation manners of the control apparatus are similar to above-described examples, descriptions of which are not repeated here.

In some embodiment, a movement direction of the movable platform may be determined, and the orientation of the movable platform may be controlled according to the movement direction of the movable platform, to ensure that the detection device can detect obstacles in the movement direction, and to prevent possible collisions resulting from the detection device being unable to detect obstacles in the movement direction of the movable platform when the detection direction of the detection device is inconsistent with the movement direction of the movable platform. Accordingly, operation safety of the movable platform can be improved.

FIG. 19 illustrates a block diagram of another example of the control apparatus 180 according to various disclosed embodiments of the present disclosure. As shown in FIG. 19, the control apparatus 180 further includes a filter circuit 183, a substitution circuit 184, and a receiving circuit 185 in addition to the determination circuit 181 and the control circuit 182. The determination circuit 181 may be further configured to determine an angle indicating the movement direction according to a ratio of the movement velocities of the UAV in the X-axis direction and the Y-axis direction in the world coordinate system. The filter circuit 183 may be configured to filter the angle indicating the movement direction to obtain the movement direction of the UAV in the world coordinate system.

Before the filter circuit 183 performs filtering on the angle indicating the movement direction, if an absolute value of a difference between an angle indicating a movement direction at a preceding time point and an angle indicating a movement direction at a subsequent time point is greater than a preset value, the determination circuit 181 may determine a substitution angle. The substitution circuit 184 may be configured to replace the angle indicating the movement direction at the subsequent time point with the substitution angle to cause angles indicating the movement directions to be continuous at time points. The angle indicating the movement direction may be an angle of the movement direction relative to a reference direction.

To determine the substitution angle, the determination circuit 181 may determine a first minor arc corresponding to a rotation from the movement direction of the UAV at the preceding time point to the movement direction of the UAV at the subsequent time point; and determining the substitution angle according to the angle indicating the movement direction at the preceding time point and a central angle corresponding to the first minor arc.

In some embodiments, to control the orientation of the UAV according to the movement direction of the UAV, the control circuit 182 may control the detection direction of the detection device to be consistent with the movement direction of the UAV.

In some embodiments, the determination circuit 181 may determine a rotation direction of the UAV from a current detection direction of the detection device to the movement direction of the UAV, and the control circuit 182 may control the UAV to rotate according to the rotation direction.

To determine the rotation direction of the UAV from the current detection direction of the detection device to the movement direction of the UAV, the determination circuit 181 may determine a second minor arc corresponding to a rotation of the UAV from the current detection direction of the detection device to the movement direction of the UAV according to the movement direction of the UAV and the current detection direction of the detection device; determine a rotation angle of the photographing direction of the photographing device at the gimbal of the UAV relative to the detection direction of the detection device, where the rotation of the photographing direction relative to the detection direction may be around the yaw axis of the gimbal; and determine a rotation direction of the UAV according to the rotation angle. The rotation direction of the UAV may include at least one of a direction indicated by the second minor arc or a direction indicated by a major arc corresponding to the second minor arc.

In some embodiments, if the rotation angle is greater than a stop angle of the yaw axis of the gimbal, the determination circuit 181 may determine the direction indicated by the major arc as the rotation direction of the UAV. If the rotation angle is smaller than or equal to the stop angle of the yaw axis of the gimbal, the determination circuit 181 may determine the direction indicated by the second minor arc as the rotation direction of the UAV.

A rotation of the photographing device at the gimbal in the yaw direction may be performed around the yaw axis, and a rotation of the detection direction of the UAV detection device in the yaw direction may be performed around the yaw axis.

In some embodiments, the determination circuit 181 may be further configured to determine a rotation speed of the UAV according to a movement direction of the UAV and a current detection direction of the detection device.

The control circuit 182 may be further configured to control the UAV to move in a gimbal coordinate system. In the gimbal coordinate system, a center of the fuselage of the UAV may serve as an origin, and a positive direction of an X-axis may be a direction pointing from the center of the fuselage of the UAV to a target object for photographing. The gimbal coordinate system may be a left-hand coordinate system. In some embodiments, as shown in FIG. 19, the control apparatus 180 further includes a receiving circuit 185 configured to receive a control amount of the controller. The control circuit 182 may be configured to control the UAV to move in the gimbal coordinate system according to the control amount of the controller. In some embodiments, the control circuit 182 may be configured to perform at least one of: controlling the UAV to move in the X-axis direction in the gimbal coordinate system; controlling the UAV to move in the Y-axis direction in the gimbal coordinate system; controlling the UAV to move in the Z-axis direction in the gimbal coordinate system; or controlling the UAV to rotate around the Z-axis in the gimbal coordinate system.

In some embodiments, the receiving circuit 185 may be configured to perform at least one of: receiving a control amount of a pitch rod or a pitch key of a controller; receiving a control amount of a roll rod or a roll key of the controller; receiving a control amount of a throttle rod or a throttle key of the controller; or receiving a control amount of a yaw rod or a yaw key of the controller. Correspondingly, the control circuit 182 may be configured to perform at least one of: controlling the UAV to move in the X-axis direction in the gimbal coordinate system according to the control amount of the pitch rod or the pitch key of the controller; controlling the UAV to move in the Y-axis direction in the gimbal coordinate system according to the control amount of the roll rod or the roll key of the controller; controlling the UAV to move in the Z-axis direction in the gimbal coordinate system according to the control amount of the throttle rod or the throttle key of the controller; or controlling the UAV to rotate around the Z-axis serving as a rotation axis in the gimbal coordinate system according to the control amount of the yaw rod or the yaw key of the controller.

In some embodiments, the control circuit 182 may be further configured to control an attitude of the gimbal carried by the UAV, such that the photographing device at the gimbal may track and photograph the target object.

In some embodiments, the principles and implementation manners of the control apparatus are similar to above-described examples, descriptions of which are not repeated here.

In some embodiments, a preset filter may be configured to filter an angle indicating a movement direction of the UAV at each time point to filter out noise interference in the angle indicating the movement direction at each time point, and to improve a detection accuracy for the movement direction of the UAV. As a result, a rotation direction of the UAV may be determined. The gimbal can be prevented from reaching the stop angle of the yaw axis when the UAV rotates from the current orientation to the movement direction of the UAV. As such, the rotation angle of the gimbal around the yaw axis remains within a range of the stop angles of the yaw axis. Accordingly, failure of the gimbal and the photographing device may be avoided.

The present disclosure provides a control method, a control apparatus, a control device, and a movable platform. The method may include determining a movement direction of a movable platform; controlling an orientation of the movable platform according to the movement direction of the movable platform, such that a detection device at the movable platform can detect obstacles in the movement direction. In the present disclosure, the orientation of the movable platform may be controlled according to the movement direction of the movable platform, to ensure that the detection device can detect obstacles in the movement direction, and to prevent the detection device from being unable to detect obstacles in the movement direction of the movable platform when the detection direction of the detection device is inconsistent with the movement direction of the movable platform. Accordingly, operation safety of the movable platform can be improved.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, or a processor to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A control method comprising:
determining a movement direction of a movable platform; and
controlling, according to the movement direction of the movable platform, an orientation of the movable platform to cause a detection device carried by the movable platform to approximately align with the movement direction.

2. The method according to claim 1, wherein determining the movement direction of the movable platform includes:
determining the movement direction of the movable platform according to a displacement of the movable platform.

3. The method according to claim 1, wherein determining the movement direction of the movable platform includes:
determining the movement direction of the movable platform according to a movement velocity of the movable platform.

4. The method according to claim 3, wherein determining the movement direction of the movable platform according to the movement velocity of the movable platform includes:
determining a movement direction of the movable platform in a world coordinate system according to an X-component of the movement velocity in an X-axis direction in the world coordinate system and a Y-component of the movement velocity in a Y-axis direction in the world coordinate system.

5. The method according to claim 4, wherein determining the movement direction of the movable platform in the world coordinate system includes:
determining the movement direction of the movable platform in the world coordinate system according to a ratio between the X-component of the movement velocity and the Y-component of the movement velocity.

6. The method according to claim 5, wherein determining the movement direction of the movable platform in the world coordinate system according to the ratio includes:
determining an angle indicating the movement direction according to the ratio; and
filtering the angle indicating the movement direction to obtain the movement direction of the movable platform in the world coordinate system.

7. The method according to claim 6, wherein determining the movement direction of the movable platform in the world coordinate system according to the ratio further includes, before filtering the angle indicating the movement direction and if an absolute value of a difference between a preceding angle indicating the movement direction at a preceding time point and a subsequent angle indicating the movement direction at a subsequent time point is greater than a preset value:
determining a substitution angle; and
replacing the subsequent angle with the substitution angle as the angle indicating the movement direction.

8. The method according to claim 1, wherein controlling the orientation of the movable platform includes:
controlling the movable platform to rotate such that a detection direction of the detection device coincides with the movement direction of the movable platform.

9. The method according to claim 1, wherein controlling the orientation of the movable platform includes:
determining a rotation direction of the movable platform from a current detection direction of the detection device to the movement direction of the movable platform; and
controlling the movable platform to rotate according to the rotation direction.

10. The method according to claim 9, wherein determining the rotation direction of the movable platform includes:
determining a minor arc corresponding to a rotation of the movable platform from the current detection direction of the detection device to the movement direction of the movable platform according to the movement direction of the movable platform and the current detection direction of the detection device;
determining a rotation angle of a photographing direction of a photographing device carried by a gimbal of the movable platform rotating around a yaw axis of the gimbal relative to the detection direction of the detection device, the rotation angle corresponding to a direction indicated by the minor arc; and
determining, according to the rotation angle, a rotation direction of the movable platform, the rotation direction of the movable platform including at least one of a direction indicated by the minor arc or a direction indicated by a major arc corresponding to the minor arc.

11. The method according to claim 10, wherein determining the rotation direction of the movable platform according to the rotation angle includes:
if the rotation angle is larger than a stop angle of the yaw axis of the gimbal, determining the direction indicated by the major arc as the rotation direction of the movable platform; and
if the rotation angle is small than or equal to the stop angle of the yaw axis of the gimbal, determining the direction indicated by the minor arc as the rotation direction of the movable platform.

12. A control device comprising:
one or more processors; and
a memory storing instructions that, when executed by the one or more processors, cause the one or more processors to:
determine a movement direction of a movable platform; and
control, according to the movement direction of the movable platform, an orientation of the movable platform to cause a detection device carried by the movable platform to approximately align with the movement direction.

13. The control device according to claim 12, wherein the instructions further cause the one or more processors to, when determining the movement direction of the movable platform:
determine the movement direction of the movable platform according to a displacement of the movable platform.

14. The control device according to claim 12, wherein the instructions further cause the one or more processors to, when determining the movement direction of the movable platform:
determine the movement direction of the movable platform according to a movement velocity of the movable platform.

15. The control device according to claim 14, wherein the instructions further cause the one or more processors to, when determining the movement direction of the movable platform according to the movement velocity of the movable platform:
determine a movement direction of the movable platform in a world coordinate system according to an X-component of the movement velocity in an X-axis direction in the world coordinate system and a Y-component of the movement velocity in a Y-axis direction in the world coordinate system.

16. The control device according to claim 15, wherein the instructions further cause the one or more processors to, when determining the movement direction of the movable platform in the world coordinate system:
determine the movement direction of the movable platform in the world coordinate system according to a ratio between the X-component of the movement velocity and the Y-component of the movement velocity.

17. The control device according to claim 16, further comprising:
a filter communicatively coupled to the one or more processor,
wherein:
the instructions further cause the one or more processors to determine an angle indicating the movement direction of the movable platform according to the ratio; and
the filter is configured to filter the angle indicating the movement direction to obtain the movement direction of the movable platform in the world coordinate system.

18. The control device according to claim 17, wherein the instructions further cause the one or more processors to, before the filter filters the angle indicating the movement direction and if an absolute value of a difference between a preceding angle indicating the movement direction at a preceding time point and a subsequent angle indicating the movement direction at a subsequent time point is greater than a preset value:
determine a substitution angle; and
replace the subsequent angle with the substitution angle as the angle indicating the movement direction.

19. The control device according to claim 12, wherein the instructions further cause the one or more processors to, when controlling the orientation of the movable platform:
control the movable platform to rotate such that a detection direction of the detection device coincides with the movement direction of the movable platform.

20. The control device according to claim 12, wherein the instructions further cause the one or more processors to, when controlling the orientation of the movable platform:
determine a rotation direction of the movable platform from a current detection direction of the detection device to the movement direction of the movable platform; and
control the movable platform to rotate according to the rotation direction.

21. The control device according to claim 20, wherein the instructions further cause the one or more processors to, when determining the rotation direction of the movable platform:
determine a minor arc corresponding to a rotation of the movable platform from the current detection direction of the detection device to the movement direction of the movable platform according to the movement direction of the movable platform and the current detection direction of the detection device;
determine a rotation angle of a photographing direction of a photographing device carried by a gimbal of the movable platform rotating around a yaw axis of the gimbal relative to the detection direction of the detection device, the rotation angle corresponding to a direction indicated by the minor arc; and
determine, according to the rotation angle, a rotation direction of the movable platform, the rotation direction of the movable platform including at least one of a direction indicated by the minor arc or a direction indicated by a major arc corresponding to the minor arc.

22. The control device according to claim 21, wherein the instructions further cause the one or more processors to, when determining the rotation direction of the movable platform according to the rotation angle:
determine the direction indicated by the major arc as the rotation direction of the movable platform, if the rotation angle is larger than a stop angle of the yaw axis of the gimbal; and
determine the direction indicated by the minor arc as the rotation direction of the movable platform, if the rotation angle is smaller than or equal to the stop angle of the yaw axis of the gimbal.
